(19) United States
(12) Patent Application Publication
(10) Pub. No.: US 2026/0125280 A1
(43) Pub. Date: May 7, 2026

(54) AEROSOL-BASED HIGH-TEMPERATURE SYNTHESIS OF MATERIALS WITH COMPOSITIONAL GRADIENT

(71) Applicants: PRINCETON UNIVERSITY, Princeton, NJ (US); HiT NANO, INC., Princeton, NJ (US)

(72) Inventors: Yiguang JU, Princeton, NJ (US); Xiaofang Yang, Ambler, PA (US); Jingning Shan, Lawrenceville, NJ (US); Christopher Abram, Trenton, NJ (US)

(21) Appl. No.: 19/427,943

(22) Filed: Dec. 19, 2025

Related U.S. Application Data
(63) Continuation of application No. 17/438,008, filed on Sep. 10, 2021, now abandoned.
(60) Provisional application No. 62/817,453, filed on Mar. 12, 2019.

(51) Int. Cl. C01G 53/50

(52) U.S. Cl. CPC C01G 53/50; C01P 2002/85; C01P 2004/03; C01P 2004/52; C01P 2004/62

(57) ABSTRACT

A material synthesis method may comprise: obtaining at least one liquid precursor solution comprising one or more solutes determined based on atomic stoichiometry of target particles; adding the at least one liquid precursor solution to an atomizer device; generating at the atomizer device an aerosol; transporting the aerosol to a reactive zone of a predetermined temperature for a predetermined time; and obtaining synthesized particles by evaporating one or more solvents from the aerosol in the reactive zone.

### CROSS REFERENCE TO RELATED APPLICATIONS

The present application is a continuation of U.S. Patent Application No. 17/438,008, filed on September 10, 2021, titled “Aerosol-Based High-Temperature Synthesis of Materials with Compositional Gradient,” which is a national stage application under 35 U.S.C. §371 of International Application No. PCT/US2020/022147, titled “Aerosol-Based High-Temperature Synthesis of Materials With Compositional Gradient,” filed on March 11, 2020, which is based on and claims priority of benefit to U.S. Provisional Application No. 62/817,453, filed on March 12, 2019, titled “Aerosol-based High-temperature Synthesis of Materials with Compositional Gradient.” The contents of all of the above-referenced applications are hereby incorporated by reference in their entirety.

### STATEMENT OF U.S. GOVERNMENT SUPPORT

This invention was made with government support under Grant No. CMMI-1449314 awarded by the National Science Foundation and Grant No. DE-SC0019893 awarded by the Department of Energy. The government has certain rights in the invention.

### TECHNICAL FIELD

The present invention relates to the field of material science and engineering, and in particular, to high-temperature synthesis of functional nanoparticles with compositional gradient.

### BACKGROUND

Nanostructured materials like nanoparticles and thin films have significant impacts in energy-related and various other applications for their unique properties. Existing methods for producing materials in such applications have various disadvantages. For instance, solid state reactions can be used to produce metal oxide or lithium orthosilicate particles for thermochemical energy storage, but the particle size and shape are difficult to control and subsequent milling/washing steps are required. Wet chemical (co-precipitation) methods can be used to produce battery cathode materials but the processing time is very long (24 hours) and large volumes of toxic waste are produced. Usually the size distribution of the synthesized particles is broad, so separation/sieving (such as by air jet siever) is required, which reduces the product yield. Furthermore, the particle size of particles produced with the above-discussed methods is generally submicron or less, which is unlikely to meet the requirement for particles larger than micron primary structures in battery electrode. Lastly, some aerosol techniques such as spray drying or spray flames use either highly dilute precursor solutions or expensive organometallic precursors to achieve particle size control, which poses as a significant hurdle for mass production. In addition, the lack of precise temperature and vaporization control in the spray flame pyrolysis methods makes it difficult to control particle morphology and concentration distribution inside the particles. Other conventional atomization technologies require high atomization energy and have poor prospects for industrial scale-up due to their high production costs.

In addition, with the existing co-precipitation method, it is difficult to accurately control an addition of an element in a small amount due to the large disparity in chemical equilibrium constants of precipitation reactions. It may be also difficult to co-precipitate more than 3 types of ions. For heavy-metal ions to co-precipitate together in the solution, the equilibrium constants of the ions need to be the same, so that the ions can precipitate according to a certain ratio. However, to have the M elements in metal salts such as nitrates (M(NO₃)ₓ.yH₂O), chlorides (MClₓ), acetates M(O₂C₂H₃)ₓ·yH₂O), etc. precipitate in a certain ratio, the equilibrium constants of the chemical reactions with these metal salts in the solution can vary greatly. So one has to constantly adjust the equilibrium by, for example, changing the pH value, stirring the solution with different strengths, changing the precipitation time by adding additional ligand (e.g., NH₃). As such, the control of an actual operation can be very difficult, and the required similar equilibrium constants can be very hard to achieve.

In the present disclosure, we present an aerosol based high temperature synthesis method with precise temperature, vaporization, and precipitation control that is not limited by any precipitation equilibrium constants. The method can also accurately control doping of 0.01 %-10 % multiple elements in their concentrations. The method can be used for designing material compositions and structures to improve electrochemical performance, thermal stability, and fire propensity, e.g., capacity, coulombic efficiency, rate performance, cycle-life, oxygen release from charged cathode materials, and spontaneous ignition for the applications in lithium-ion batteries.

### SUMMARY

Systems and methods for synthesizing various materials (e.g., electrochemically, thermochemically, or opto-electronically active materials) are disclosed. Such materials can be used for energy conversion and storage and catalytic chemical synthesis.

According to one aspect of the present disclosure, a material synthesis method may comprise: adding at least one liquid precursor solution to an atomizer device; generating by the atomizer device an aerosol comprising liquid droplets; transporting the aerosol to a reactive zone for evaporating one or more solvents from the aerosol; and collecting synthesized particles.

According to another aspect, a material synthesis system may comprise: an atomizer device for receiving at least one liquid precursor solution to generate an aerosol comprising liquid droplets; an atomizer channel; and a reactor. The atomizer channel is connected to the atomizer device at a first end and to the reactor at a second end. The atomizer channel is at least for transporting the aerosol to the reactor. The reactor comprises a temperature-controlled reactive zone by using a novel inwardly off-center shearing (IOS) jet-stirred reactor (JSR), and low temperature flames such as cool flames and warm flames for evaporating one or more solvents from the aerosol to obtain synthesized particles.

According to another aspect of the present disclosure, a material synthesis method may comprise adding a first precursor solution to an atomizer device to generate a first aerosol comprising first liquid droplets, transporting the first aerosol to a reactive zone for evaporating one or more first solvents from the first aerosol to obtain first synthesized particles of a first size distribution, adding a second precursor solution to the atomizer device to generate a second aerosol comprising second liquid droplets, and transporting the second aerosol to the reactive zone for evaporating one or more second solvents from the second aerosol to obtain second synthesized particles of a second size distribution.

According to another aspect of the present disclosure, a material synthesis method may comprise selecting solutes and solution for ions with target concentration gradient and/or precision doping, controlling the solubility of the different solutes in the solution for forming particles with a compositional gradient, and/or controlling ion doping mole fraction; generating a micro aerosol by using an aerosol generator, such as an atomizer device; transporting the aerosol to a reactive zone for evaporating one or more solvent from the aerosol; controlling the vaporization rate of the aerosol and the diffusion and precipitation rates of the solute by choosing appropriate temperature and vaporization time; forming nano-materials with concentration gradient and/or precise ion-doping; and collecting synthesized particles. In some embodiments, the ion doping, for example, lanthanide ion or any other oxygen coordination ion doping, with a concentration gradient formation may improve materials electrochemical performance and fire safety, such as capacity, coulombic efficiency, rate performance, cycle-life, oxygen release from charged cathode materials, and spontaneous ignition for the applications in lithium-ion batteries.

The present disclosure provides another material synthesis method. The method may comprise: obtaining at least one liquid precursor solution comprising one or more solutes determined based on atomic stoichiometry of target particles; adding the at least one liquid precursor solution to an atomizer device; generating at the atomizer device an aerosol; transporting the aerosol to a reactive zone of a predetermined temperature for a predetermined time; and obtaining synthesized particles by evaporating one or more solvents from the aerosol in the reactive zone.

The present disclosure further provides another material synthesis system. The system may include an atomizer device configured to receive at least one liquid precursor solution and generate an aerosol from the at least one liquid precursor; and a reactor comprising: a preheating zone and a reactive zone. The at least one liquid precursor solution may include one or more solutes based on atomic stoichiometry of target particles. The preheating zone is configured to preheat the aerosol; and the reactive zone is configure to evaporate one or more solvents from the aerosol and obtain the synthesized particles that match the target particles.

These and other features of the systems and methods disclosed herein, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

The disclosed systems and methods can be used to design nanomaterials with compositional gradient from the center to the surface and to add a precise amount of ion-doping into the nanomaterials to improve the performance and fire safety of nanomaterials. The applications of such materials can be for high nickel cathodes of lithium ion batteries for electrical vehicles, thermal chemical materials for energy storage, catalysts, and photonics.

### BRIEF DESCRIPTION OF THE DRAWINGS

Certain features of various embodiments of the present technology are set forth with particularity in the specification. A better understanding of the features and advantages of the technology will be obtained by reference to the following detailed description that sets forth illustrative embodiments, in which the principles of the invention are utilized, and the accompanying drawings of which:

FIG. 1 is a flowchart illustrating an exemplary material synthesis method, consistent with various embodiments of the present disclosure.

FIG. 2A is a graphical illustration of the exemplary material synthesis method, consistent with various embodiments of the present disclosure.

FIG. 2B are respectively schematic of the materials synthesis procedures and time sequence (left) and the Scanning Electron Microscope (SEM) images of exemplary synthesized nanoparticles by using different solvents, consistent with various embodiments of the present disclosure.

FIG. 3A is a graphical illustration of an atomizer device, consistent with various embodiments of the present disclosure.

FIG. 3B is a graphical illustration of aerosol generation using the atomizer, consistent with various embodiments of the present disclosure.

FIG. 3C is a graphical illustration of an inwardly off-center shearing (IOS) jet-stirred reactor (JSR) for uniform temperature control and spray vaporization, consistent with various embodiments of the present disclosure.

FIG. 4A-4D are respectively direct images of a diffusion cool flame, a premixed warm flame, a premixed cool flame and a diffusion warm flame for low temperature flame (500-1200 K) materials synthesis, consistent with various embodiments of the present disclosure.

FIG. 4E and FIG. 4F are respectively graphical illustrations of volume-based and number-based droplet size distribution for a hydrocarbon-liquid-fuel-based precursor solution in the sub-micron mode, consistent with various embodiments of the present disclosure.

FIG. 4G and FIG. 4H are respectively graphical illustrations of volume-based and number-based droplet size distribution for a water-based precursor solution for the dual-mode, consistent with various embodiments of the present disclosure.

FIG. 4I is a graphical illustration of SEM data of an exemplary high nickel cathode material, consistent with various embodiments of the present disclosure.

FIG. 4J is a graphical illustration of energy-dispersive X-ray (EDX) mapping data of an exemplary high nickel cathode material, consistent with various embodiments of the present disclosure.

FIG. 4K is a graphical illustration of cycling performance of exemplary nanoparticles, consistent with various embodiments of the present disclosure.

FIG. 5A is a graphical illustration of a formation of a cathode nanomaterial with concentration gradient and precision doping, consistent with various embodiments of the present disclosure.

FIG. 5B is an X-ray photoelectron spectroscopy data of a fluorine doped high nickel cathode material, consistent with various embodiments of the present disclosure.

FIG. 5C and 5D are respectively graphical illustrations of oxygen release data as a function of temperature for exemplary cathode materials with and without electrolyte solvents, consistent with various embodiments of the present disclosure.

FIG. 6 is a flowchart illustrating an exemplary material synthesis method, consistent with various embodiments of the present disclosure.

FIG. 7 is a flowchart illustrating an exemplary material synthesis method, consistent with various embodiments of the present disclosure.

FIG. 8 is a flowchart illustrating an exemplary material synthesis method, consistent with various embodiments of the present disclosure.

### DETAILED DESCRIPTION

As described in the background, current methods for synthesizing small structures (e.g., nanoparticles, microparticles, and thin films) are inadequate to meet the application requirements. To mitigate or overcome such disadvantages in existing technologies, various material synthesis systems and methods are disclosed.

In various embodiments, a continuous high-temperature synthesis method is disclosed. This method can be used for the production of size and morphology controlled nanomaterials. The method implements both aerosol droplets produced by an atomizer device and morphology control steps by using low temperature flames (e.g. cool flames and warm flames, or heating) and an inwardly off-center shearing (IOS) jet-stirred reactor (JSR) to produce a scalable hierarchy of nanostructured materials. For example, monodispersed or near-monodisperse ultrafine (a narrow distribution in the 5-100 nm size range, e.g., 5-10 nm, 50-60 nm, 5-20 nm, 10-30 nm, 30-50 nm, 60-80 nm, 80-100 nm) nanoparticles, polydisperse and non-aggregated particles (a broad distribution in the 5 nm-10 µm size range, e.g., 5-10 nm nanoparticles and 1-10 µm particles, or a continuous distribution in the 100 nm-10 µm size range, or combinations thereof), hollow-structured particles, and particles with concentration gradient from the surface to the center can be synthesized through the control of aerosol droplet size, preheating and mixing, and synthesis temperature. Using economically viable precursors, the produced material can have a targeted crystalline phase and element composition. Metal oxide, acetate, sulphide, nitride, chloride, fluoride, and carbonate nanoparticles as well as thin films (e.g., 5 nm -100 µm thick) can be produced based on the disclosed methods.

In some exemplary applications, cathode, electrolyte, and anode nanomaterials for electrochemical energy storage may be synthesized and used in lithium-ion batteries, sodium batteries, and solid state batteries. Other applications for the produced materials may include metal catalysts for chemical conversion of fuels, photo-active materials for optoelectronic applications (e.g., solar cells), imaging materials (e.g., scintillators, remote sensors), thermal chemical materials used in thermochemical energy storage for solar thermal power generation, thermal power plants, electrolyte materials for solid-oxide fuel cells, and functionalized surface coatings (e.g., thin films). Other applications may include materials of cosmetics, paints, inks, and nanocomposites (e.g., thin multilayer films), ultra-hard materials, communication materials (e.g., optical fiber materials, rare-earth doped materials), displays and lighting, lasers, security and labelling, counterfeiting, medical diagnosis and treatment materials (e.g., photodynamic materials, pharmaceuticals), and remote optical sensor materials.

In some embodiments, various features are disclosed for achieving a synthesis product with controllable particle size and morphology: (i) control of the droplet size distribution, where an atomizer device operates in a sub-micron mode, and the majority of droplets by number are 100-1000 nm in diameter, or the atomizer device operates in a dual mode, and the aerosol comprises both sub-micron droplets and larger droplets in the size range 1-100 µm, allowing synthesis of monodispersed ultrafine (e.g., 5-100 nm) or polydisperse (e.g., 5 nm-10 µm) nanomaterials respectively; (ii) a preheating section to control the particle size and morphology, respectively, for the production of monodispersed ultrafine particles (e.g., 5-100 nm) via a gas-to-particle synthesis process, or hollow-structured particles via a shell formation process; (iii) the synthesis temperature can be varied to produce either monodispersed ultrafine nanoparticles (e.g., 5-100 nm) or larger polydisperse particles (e.g., 5 nm-10 µm). Furthermore, regarding the material nanostructure, (iv) the applications of the atomizer device as well as the preheating and synthesis temperature control in this process can enable formation of polydisperse (e.g., 5 nm-10 µm) and monodisperse ultrafine nanoparticles (e.g., 5-100 nm); and (v) hollow-structured particles can be formed using the appropriate combination of preheating and synthesis temperature.

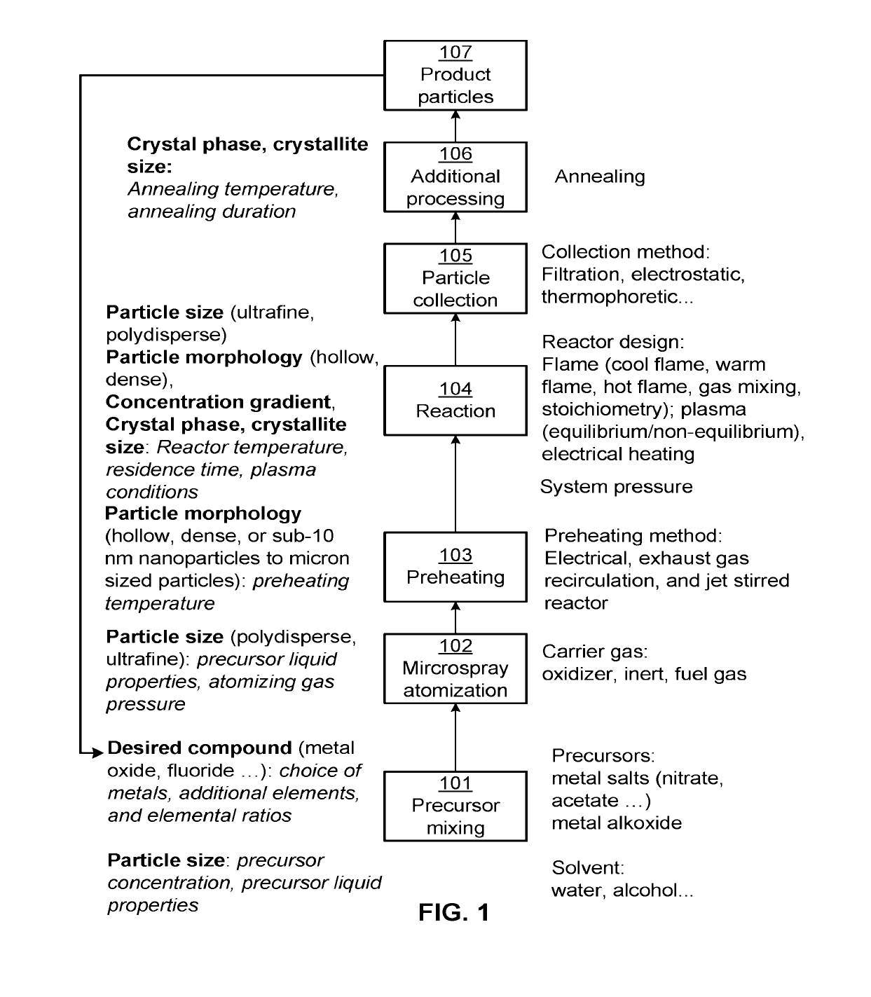

FIG. 1 is a flowchart illustrating an exemplary material synthesis method, consistent with various embodiments of the present disclosure. The disclosed exemplary material synthesis method may comprise continuous high-temperature synthesis steps for producing size and morphology controlled materials. The produced materials (e.g., nanomaterials) may be used for energy conversion, energy storage, imaging, catalysts, and functionalized surface coatings (thin films). As shown in FIG. 1, the exemplary material synthesis method may comprise steps 101-107. In FIG. 1, exemplary product particle properties controlled at each step are provided to the left of the each step, and exemplary additional process variables are provided to the right of the each step. The operations of the exemplary material synthesis method and its various steps presented herein are intended to be illustrative. Depending on the implementation, the exemplary material synthesis method may include additional, fewer, or alternative steps performed in various orders or in parallel.

Referring to FIG. 1, in some embodiments, the material synthesis method comprises: (step 101) preparing liquid precursor solutions containing target metal elements and mixing the precursor solutions; (step 102) generating an aerosol using an atomizer device; (step 103) in a continuous process, preheating the aerosol by using a fast mixing reactor (e.g. IOS-JSR) with precise temperature control (e.g., in a preheating section between 50-500 ^{o}C, such as, 50-200 ^{o}C, 100-200 ^{o}C, 200-300 ^{o}C, 300-400 ^{o}C, 400-500 ^{o}C, etc.) for 0.1-10 seconds (e.g., 0.5-5 seconds, 5-10 seconds, etc.), which allows control of the particle morphology such as formation of hollow-structured particles); (step 104) transporting the aerosol into a high-temperature reactive zone formed by using either low temperature cool flames and warm flames and/or plasma and electrical heating (e.g., the reactive zone may be at 200-10000 ^{o}C, such as, 200-1300 ^{o}C for cool flame and warm flame heating, mild combustion, and/or electrical heating, 800-3000 ^{o}C for hot flame heating, 1000-10000 ^{o}C for plasma heating, 3000-5000 ^{o}C, 5000-10000 ^{o}C, etc.) and 500 mbar-10 bar pressure (e.g., atmospheric pressure or a pressure of 1-5 bar, 5-10 bar, etc.) in which the aerosol may stay for a period of time (e.g., 0.1-100 seconds), the reactive zone facilitates the production of metal oxide, sulphide, nitride, chloride, fluoride, carbonate, and other materials), and the temperature may be controlled to produce ultrafine nanoparticles (e.g., 5-100 nm size) or larger particles (e.g., 5 nm-20 µm size); and (step 105) collecting the product particles (e.g., from an exhaust stream, depositing the product particles directly on a substrate to generate thin films). Optionally, at (step 106), additional processing (e.g., annealing) may be implemented to improve the particle crystalline structure. The synthesized material can be obtained at (step 107).

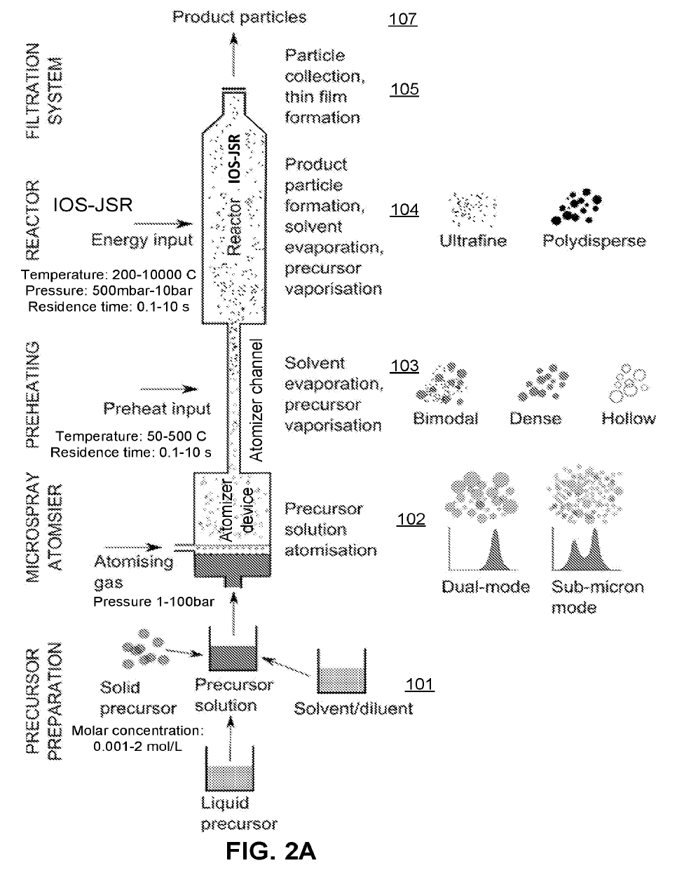

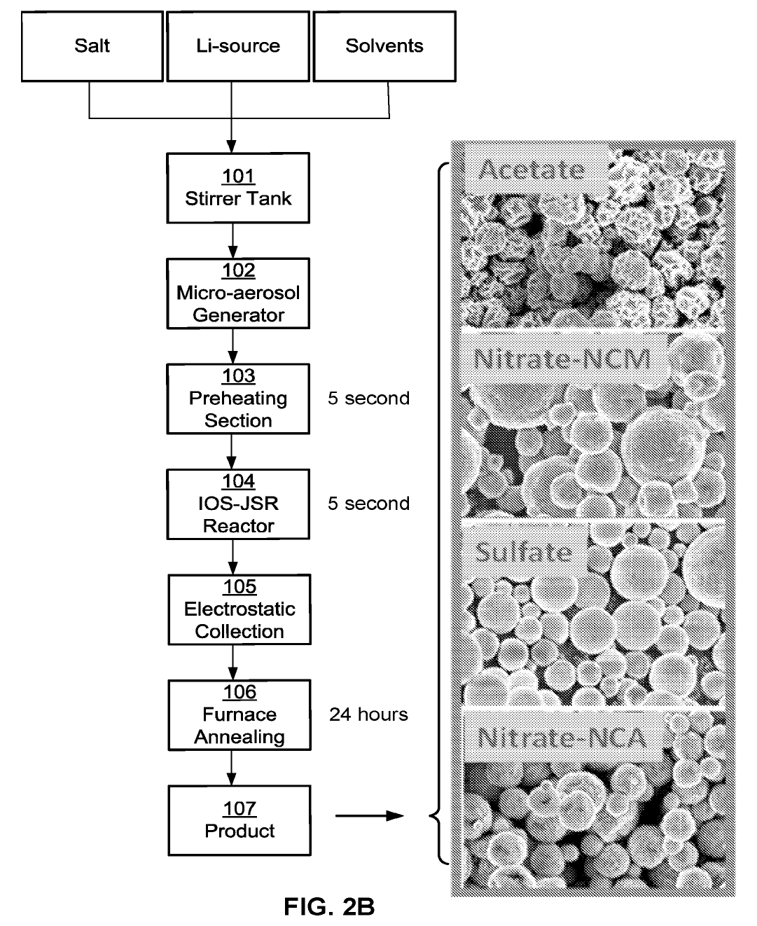

FIG. 1 can be related to FIG. 2A and FIG. 2B, which provide graphical illustrations of the exemplary material synthesis method, consistent with various embodiments of the present disclosure. FIG. 2A shows a general schematic diagram of the synthesis method. From left to right, FIG. 2A illustrates main components of the apparatus for synthesis, description of governing processes, and the aerosol droplet modes, preheating control, and product particle size distributions at certain steps. Referring to FIG. 2A, a material synthesis system may comprise: an atomizer device for receiving at least one liquid precursor solution to generate an aerosol comprising liquid droplets; an atomizer channel; and a reactor. When the atomizer device is implemented as a microspray atomizer, to generate the aerosol, the atomizer device may be configured to receive the at least one liquid precursor solution and an atomizing gas flow. The atomizer device receives the atomizing gas, which may flow from a submerged portion of the liquid precursor solution. The atomizing gas may comprise at least one of an oxidizer gas, an inert gas, or a fuel gas. The atomizing gas flow may have a pressure of 1-100 bar (e.g., 1-10 bar, 10-50 bar, 50-100 bar, etc.). The atomizer channel (e.g., tube, pipe, or an alternative structure) is connected to the atomizer device at a first end and to the reactor at a second end. The atomizer channel is at least for transporting the aerosol from the atomizer device to the reactor. The atomizer channel may comprise an optional preheating section for preheating the aerosol at a temperature between 50 ^{o}C and 500 ^{o}C for 0.1-10 seconds by either low temperature cool and warm flames and/or electrical heating. For example, when no heating is provided to the aerosol between the atomizing device and the reactor, the synthesized particles may be hollow-structured. The reactor comprises a reactive zone with a fast mixing jet stirred reactor (e.g. IOS-JSR) for evaporating one or more solvents from the aerosol at a uniform temperature between 200-10000 ^{o}C and a pressure of 500 mbar - 10 bar for 0.1-100 seconds to obtain synthesized particles. The reactive zone may comprise at least one of a flame (cool flame, warm flame, or hot flame), plasma, furnace, laser heating, or electric heating. Each step is described in more details below.

FIG. 2B shows an exemplary materials synthesis procedure in time sequence (left) and exemplary SEM images of synthesized nanoparticles obtained at Step 107, consistent with various embodiments of the present disclosure. Different solvents can be used for synthesizing the nanoparticles. For example, as shown in the SEM images, to synthesize nickel-cobalt-manganese (NCM) and nickel-cobalt-aluminum (NCA) cathode nanoparticles, solvents such as acetates, nitrates, and sulfates can be used. Further details of the material synthesis steps can be referred to in FIG. 1, FIG. 2A, and FIG. 2B.

(Step 101) precursor solution preparation and mixing. In some embodiments, the metal precursors for the product particles (e.g., oxides, silicates, oxysulphides, sulphides, fluorides, nitrides) are initially in the liquid phase or prepared accordingly. Depending on the material to be formed, salts of the metals that shall form the product particles are chosen. For example, precursor solutions used for the material synthesis method may comprise metal salt(s) (e.g., nitrate, acetate, carbonate, chloride, sulphide, hydroxide) dissolved in a solvent liquid. The metal in the metal salt(s) may comprise any alkaline, transition, or lanthanide (rare-earth) metal(s) or metalloids. For example, these metal salts may comprise nitrates (M(NO₃)ₓ.yH₂O), chlorides (MClₓ), acetates M(O₂C₂H₃)ₓ·yH₂O), etc.

In some embodiments, to prepare the precursor solutions, the metal salts are weighed to the correct atomic stoichiometry as desired in the product particles. The salts (solute) are then dissolved in a liquid (solvent). The solvent liquid may comprise water, that is, the solvent does not need to be a fuel that participates in the chemical reaction by releasing heat. In other realizations of the material synthesis method the solvent may be a source of additional heat generation. For example, the solvent may comprise ethanol, butanol, isopropanol, ethylene glycol, acetic acid, alcohol liquids, or other liquid hydrocarbon fuel and combinations of these. Alternatively, the precursor solution may comprise a metal alkoxide (e.g., titanium isopropoxide, tetraethyl orthosilicate) and may be diluted with ethanol. Where the material to be synthesized is a fluoride, ammonium fluoride may be used as a precursor. Where the material to be synthesized is a sulphide or oxysulphide, sulphur chloride may be used as a precursor.

The elemental ratio of the metallic ions in the precursor solution controls the composition of the product particles. In some embodiments, the molar concentration of the precursor liquid may be between 0.001-2 mol/L (e.g., in the range of 0.1-2 mol/L, 0.001-1 mol/L, 0.1-1 mol/L, 1-2 mol/L, etc.), allowing additional control of the product particle size. In the droplet to particle formation mode described below, higher precursor concentrations will result in larger particles being produced.

In some embodiments, the solubility of different metal precursors may be different, causing preferential precipitation of some ions with lower solubility and lead to the formation of concentration gradients of specific metal elements. The concentration gradient formation in the aerosol particles is determined by ion diffusion, ion precipitation and solvent evaporation, which are controlled by adjusting the drying gas temperature, residence time, and chemical properties of the precursors. Evaporation of the solvent from the surface of the particles causes the precursor to precipitate on the surface, which is primarily determined by the solubility of the precursor. Precursors with low solubility preferentially precipitate on the surface, resulting in a higher concentration of the precursor on the surface of the particles. The solvent inside the particles diffuses from the core to the shell while the ions diffuse in the opposite direction. In the case of a mixed precursor system, as the drying process propagates from the surface to the core, precursors with lower solubilities gradually precipitate from the surface to the core, which results in a gradient concentration of different ions in the particles. Accordingly, by carefully choosing the heating and vaporization rates as well as the solubility of the metal precursors, the concentration of metal elements in the product particles may form a compositional gradient from the center to the surface. For example, when using a precursor solution containing aluminum and nickel nitrates for synthesizing nanomaterials, the atomic concentration of nickel can be very different from that of aluminum across the particle. Due to high solubility of nickel nitrate, the surface of the nanoparticles may have a relatively low concentration of nickel, and the concentration of nickel may gradually increase from the surface to the center. In contrast, the aluminum’s concentration may change in an opposite direction, i.e., the concentration of aluminum increases from the center to the surface of the nanoparticles.

In some embodiments, cathode, electrolyte, and anode nanomaterials may be synthesized as battery materials, and can be used in lithium-ion batteries, sodium batteries, and solid state batteries. For example, mixtures of NCM nano-materials are often used as the cathode nanomaterials in lithium-ion batteries. In some embodiments, nanoparticles with a compositional gradient of nickel (i.e., high concentration of nickel at the center and low concentration of nickel on the surface) can be used to improve the stability and electrochemical performance of the high nickel concentration materials. Such materials can be used for high nickel cathodes of lithium ion batteries for electrical vehicles, thermal chemical materials for energy storage, catalysts, photonics, etc. A higher concentration of nickel can increase the energy density but decrease the stability of the cathode nanomaterials. In some embodiments, to increase the stability of the NCM cathode nanomaterials, the concentration of manganese may be relatively higher on the surface and lower at the center; and the concentration of nickel may be relatively lower on the surface and higher at the center. For example, the atomic ratio of nickel, cobalt and manganese at the center can be 0.9:0.05:0.05 and it can gradually change to 0.3:0.3:0.3 (NCM111) on the surface. The role of cobalt and manganese ions is to improve the cycling performance of the battery materials and thermal stability.

In various embodiments, materials with the concentration-gradient structure can be synthesized by controlling the solubility of different solutes in micro-aerosols and by using the controlled-high-temperature (MACHT) vaporization and pyrolysis process. This method can be called preferential precipitation, or preferential crystallization. Synthesizing materials using the method of preferential precipitation is more advantageous than synthesizing materials with co-precipitation methods. High concentrations of nickel on the surface of the cathode materials may not be stable and may cause the batteries to catch fire. Thus, in order to increase the surface stability, the particles produced by common precipitation methods may require coating on the surface or doping in the bulk. The method of coating often involves mixing cathode particles with the coating precursor solution to form a thin liquid film on the surface, and then drying the particles in a furnace to form a solid coating layer. The bonding between the coating film and the particles may not be very strong. Therefore, the coating film may be detached from the particles as the cathode materials expand and contract during charge-discharge cycles. Thus, by utilizing the preferential precipitation method, inactive materials such as aluminum and manganese can be preferentially precipitated on the surface to achieve a high concentration of nickel at the center and a low concentration of nickel on the surface. This concentration gradient structure may improve stability and better performance for the battery cycling.

In some embodiments, controlling the solubility of different solutes can be used for precision doping, i.e., precisely doping ions into the target materials with a precise molar concentration. For example, fluorine, manganese, and zirconium can be doped into nickel-rich particles to form a compact structure on the surface. High nickel cathode materials tend to release oxygen gas when the temperature of the battery is high. The released oxygen gas may react strongly with the organic solvent in the electrolyte and may even ignite the flammable solvent and cause a battery fire. For example, when the concentration of nickel is higher than 60%, the charged cathode materials in a battery tend to catch fire at elevated temperatures. In some embodiments, the battery fire can be reduced or even prevented by doping fluorine in the high nickel cathode nanomaterials. As fluorides are less soluble than nitrates, a fluoride gradient is formed from the surface to the center. By varying the initial concentration of fluorine in the solution, particles with different concentration gradient structures may be produced. In some embodiments, the particle surface may be passivated by a nano-layer fluoride. Since the fluorine anion has only one negative charge, the oxidation state of nickel having fluorine as a ligand is lowered as compared with nickel in the oxide. This strongly inhibits the damage of the highly oxidized nickel to the electrolyte, thereby improving the stability of the battery performance. Different elements can be doped into the cathode nanomaterials. In some embodiments, aluminum, zirconium, magnesium, cerium, fluorine, silver, antimony, tantalum, titanium, or other oxygen coordination ions can be doped into the NCM cathode nanomaterials. For example, adding 0.01%-1% of zirconium can be used to improve battery cycling. One or more elements can be doped at the same time, for example aluminum and zirconium can be doped at the same time. Different precursors may have different solubilities, when precipitated from the solution, the formed gradients may also be different. The ratio of elements in the starting solution is the same as the average ratio of the elements in the synthesized materials. In some embodiments, the concentration of a single or multiple ions can be between 0.01%-10% at the mole fractions.

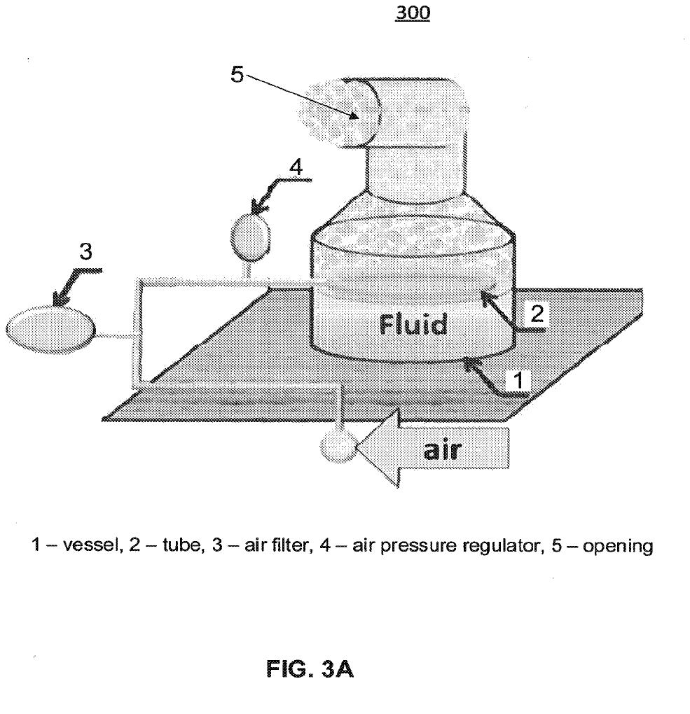

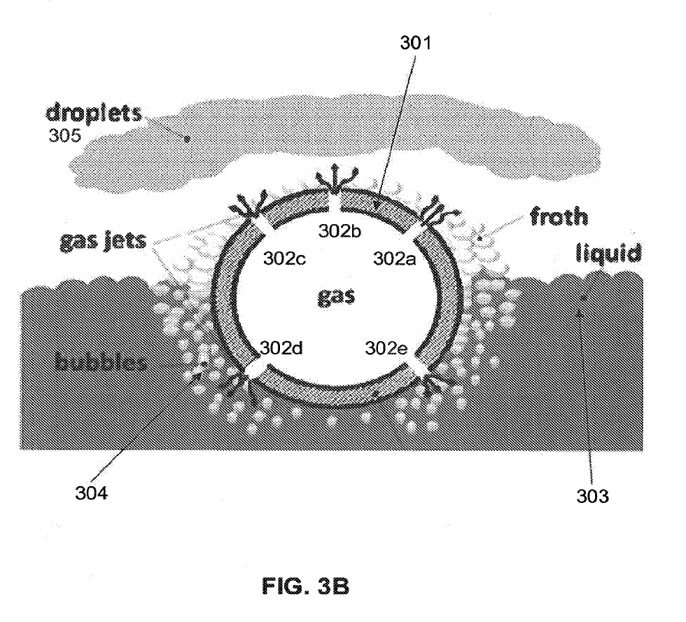

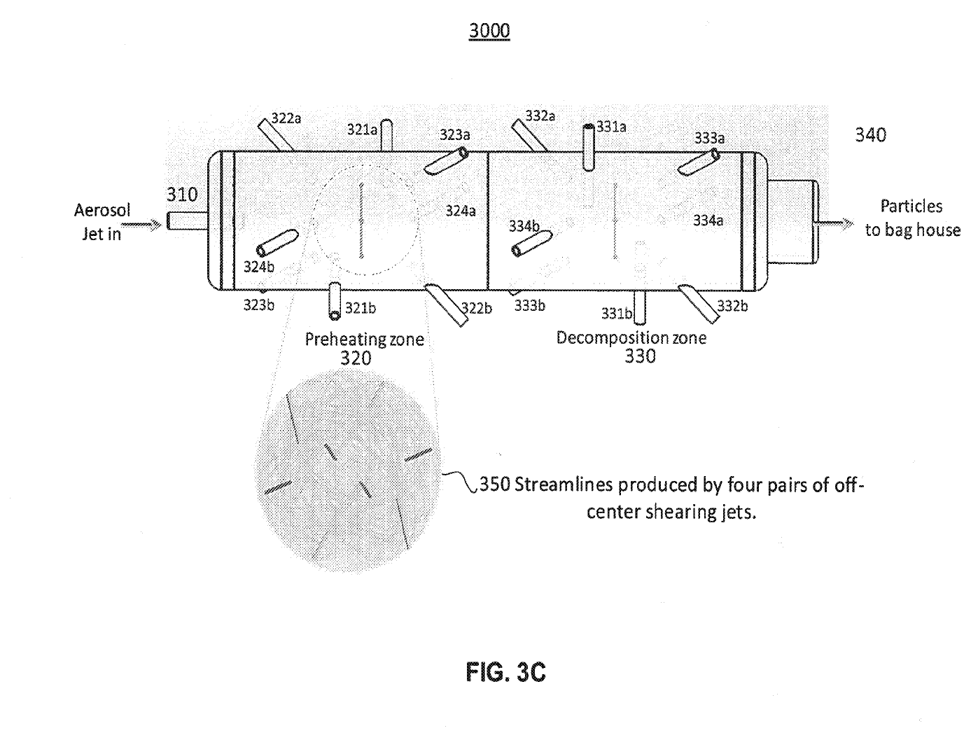

(Step 102) aerosol generation by atomization. In some embodiments, the prepared precursor solution is atomized, for example, in an atomizer device. For example, the liquid precursor solution is contained in a chamber of the atomizer device (e.g., microspray atomizer, ultrasonic nebulizer for producing micron-sized droplets, pressure nozzle such as a diesel injector, etc.). For the descriptions below including FIG. 3A and FIG. 3B, the atomizer device is implemented as a microspray atomizer. A regulated atomizing gas flow (e.g., air, nitrogen, argon, or any tailored fuel or oxidizer mixture) is introduced into the atomizer device. The choice of atomizing gas may depend on the downstream high-temperature process of the material synthesis method. The pressure of the atomizing gas may be between 1-100 bar. The atomizing gas may comprise at least one of an oxidizer gas (oxygen or any oxygen-containing mixture, such as air), an inert gas (e.g., argon, nitrogen), or a fuel gas (e.g., hydrogen, or one or more carbon-containing gases such as methane, ethylene, propane, and other alkanes and oxygenated fuels like alcohols and ethers).

FIG. 3A is graphical illustration of an atomizer device 300, consistent with various embodiments of the present disclosure. The components of the exemplary atomizer device 300 presented herein are intended to be illustrative. Depending on the implementation, the atomizer device 300 may include additional, fewer, or alternative components.

In some embodiments, the atomizer device 300 may comprise a vessel 1, a tube 2, an optional air filter 3, and an air pressure regulator 4. When incorporated in the material synthesis system of FIG. 2A, the opening 5 directly connects to the atomizer channel as shown in FIG. 2A. The opening 5 may have any shape or type of connection without limitation by the illustration. The atomizer device 300 may comprise another opening for receiving the precursor solution labeled as “fluid” in FIG. 3A. The “air” shown in FIG. 3A may correspond to the atomizing gas described herein.

In some embodiments, in the vessel 1, the tube 2 (e.g., norprene tubing in a circular or other configurations), is placed to the liquid. The tube may be floating on the liquid surface and connected to the pressurized air provided with the filter 3 and the pressure regulator 4. The air flow rate may be between 1-10000 l/min or higher, or in the range 1-10 l/min, 10-100 l/min, etc. The tube 2 may be perforated with a needle having a diameter of about 0.6 mm (or alternatively at another suitable value), and approximately the same number of orifices are above and below the liquid surface (liquid/air interface). The number of orifices may be between 10 and 32 per cm, the tube may be between 1.5 and 30 cm, and the tube outer diameter may be 11 or 12 mm and inner diameter between 6 and 8.4 mm. The droplets formed in the vessel 1 rise to an exit at the opening 5. The aerosol formation can be affected by the process parameters. For example, higher diameter of the perforation needle provides larger droplets. Similarly, the thinner is film which covers the emerged orifices, the smaller are the formed droplets; the greater is the air pressure, the smaller are the droplets.

In some embodiments, inside the atomizer, compressed air may be released through a submerged lower part of a container containing the solution, forming ensembles of small bubbles. The bubbles come to the surface of the precursor liquid, forming created ensembles of thin spherical liquid films (e.g., with an estimated thickness of less than 500 nm). Simultaneously, high velocity gas jets cause the disintegration of the liquid films, forming an aerosol, which comprises precursor solution droplets suspended in the atomizing gas flow. Further details are described below with reference to FIG. 3B.

FIG. 3B is graphical illustration of aerosol generation using the atomizer, consistent with various embodiments of the present disclosure. FIG. 3B shows a cross-sectional view of the tube 2 described with reference to FIG. 3A, and the tube 2 is provided with orifices 302 (e.g., orifices 302a-302e) perforated in the walls 301 of the tube 2. The bottom portion of tube 2 is immersed in a liquid 303, and the upper portion of tube 301 is exposed to the environment. The material from which the tube 2 is produced can be of any kind that is suitable to be immersed in the liquid and can have some degree of elasticity.

In some embodiments, compressed gas (e.g., the atomizing gas described herein) is inserted into tube 301. When the compressed gas is in contact with orifices 302, the pressure difference between the compressed gas and the outer environment tend to equalize, and the compressed gas is discharged through orifices 302 by a velocity increasing with said pressure difference. The material of tube 2 (hollow body) can possess some degree of elasticity to intensify and regulate the compressed gas discharge through the orifices, to prevent liquid backflow through the orifices and also to avert clogging of the orifices when atomizing suspensions and liquids of high viscosity. For tube 2 made of elastic material, such as norprene rubber, the size of orifices perforated in the tube walls and the gas flow rate depend on the pressure of the supplied compressed gas: the higher the gas pressure, the greater will be the size of the orifices and vice versa. Moreover, because of the pressure difference between the inner and outer sides of the tube 2, the internal parts of elastic orifices 302 that are in contact with the compressed gas may have larger sizes than their outer parts that are in contact either with liquid 303 or with the environment. Therefore, the elastic orifices may have shapes close to truncated cones (e.g., with a broad end facing the inside of the tube 2 and a narrow end facing the outside of the tube 2) and may act as nozzles, accelerating the flow of the discharging compressed gas and thereby intensifying the atomization process. In addition, the elasticity of tube 2 allows orifices 302 to function as check valves, preventing backflow from liquid and environment when the compressed gas is not supplied: due to elastic expansion of the tube material, orifices perforated in the tube walls by micron needle may have zero size (will be closed) if there is no excess pressure of the compressed gas inside tube 2. In case of clogging of the orifices during the operation, the elasticity of tube 2 will have advantages because it may allow enlarging the orifice sizes by supplying higher than operating pressure of the compressed gas and thus facilitating through-scavenging of the clogs.

When the compressed gas is released through the orifices 302d and 302e that are immersed in the liquid, it creates bubbles 304 that climb up and meet compressed gas released from the orifices 302a, 302b, and 302c that are not immersed in the liquid. The thin-walled bubbles 304 are broken by the gas jets released from orifices 302a, 302b, and 302c into drops of very small size droplets 305, which are pushed away from the tube, providing a spray of the atomized liquid.

There are two sets of orifices perforated in tube walls: orifices 302 a-c that are located at the upper portion of tube 2 and are exposed to the environment, and orifices 302 d-e that are located at the lower immersed portion of tube 2, exposed to the liquid material. The number of orifices in each set (lower or immersed set, and upper or emerged set) and the diameters of the orifices of each set may be adapted to discharge target flow rates of the compressed gas through said upper and lower sets and the skilled person will easily devise orifice configurations suitable for a specific need. The tube can be straight or bent in various spatial configurations, so that said longitudinal axis may have the shape of, e.g., circle, ellipse, coil etc. Along the tube, some sections may be entirely immersed or entirely emerged, but at least some sections must be partially immersed, having the longitudinal axis located in a plane parallel or identical to the interface between the liquid and the atmosphere. Alternatively, the atomizer device can be of various other shapes and configurations, as long as it comprises a tube that contains a flow of compressed gas, is partially immersed in a liquid material, and has orifices perforated in its walls as described.

Further information of the atomizer can be found from the following publications, which are incorporated herein by reference in their entirety: (1) Mezhericher, M., Ladizhensky, I. and Etlin, I. Atomization of liquids by disintegrating thin liquid films using gas jets. International Journal of Multiphase Flow 2017, 88: 99-115; (2) Mezhericher M., Ladizhensky I. and Etlin I. U.S. Patent Application No. 15/324,902, filed January 9, 2017; (3) Mezhericher M., Ladizhensky I. and Etlin I. Liquid-atomization Method and Device. European Patent Application No. 15848995.5, filed February 23, 2017; (4) Mezhericher M., Ladizhensky I. and Etlin I. Liquid-atomization Method and Device. PCT/IL2015/050857; Publication No. WO2016/055993, published on April 14, 2016; and (5) Mezhericher M., Ladizhensky I. and Etlin I. Liquid-Atomization Method and Device. Israel Patent Application, No. 235083, filed October 7, 2014.

Referring back to FIG. 1 and FIG. 2A, in some embodiments, the atomizer device may employ a sub-micron droplet mode (e.g., droplets of a diameter of 100-1000 nm are obtained), or use a dual droplet size mode (e.g., sub-micron droplets and 1-100 µm droplets are obtained). The size distribution of the aerosol droplets may be controlled via various conditions. For example, the atomizing gas pressure or the properties of the liquid precursor may be controlled to change the droplet size. In some cases, the atomizer may be heated to adjust the properties of the precursor liquid, thereby controlling the droplet size and to facilitate efficient droplet generation. Alternatively, various other atomization methods for obtaining different droplet size distributions can be used, and combined together to produce materials with specified size distributions.

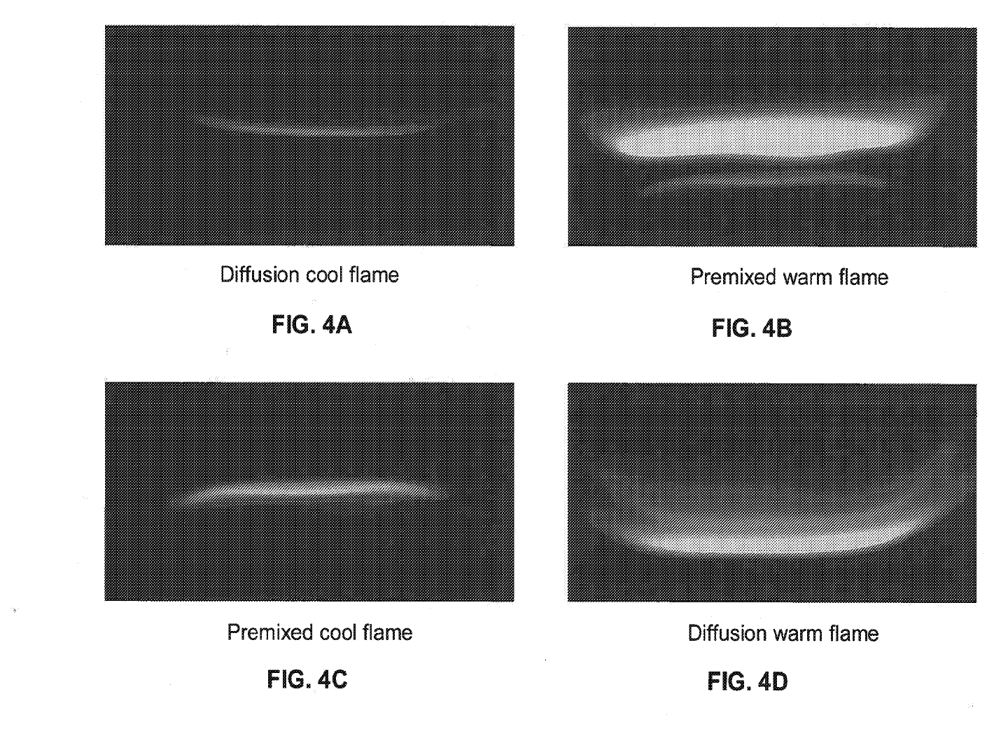

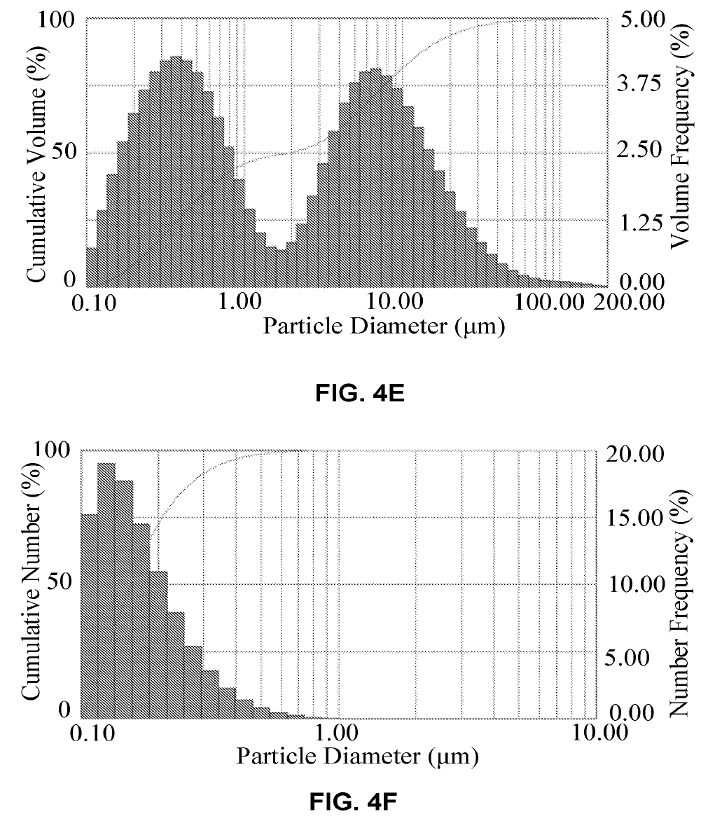

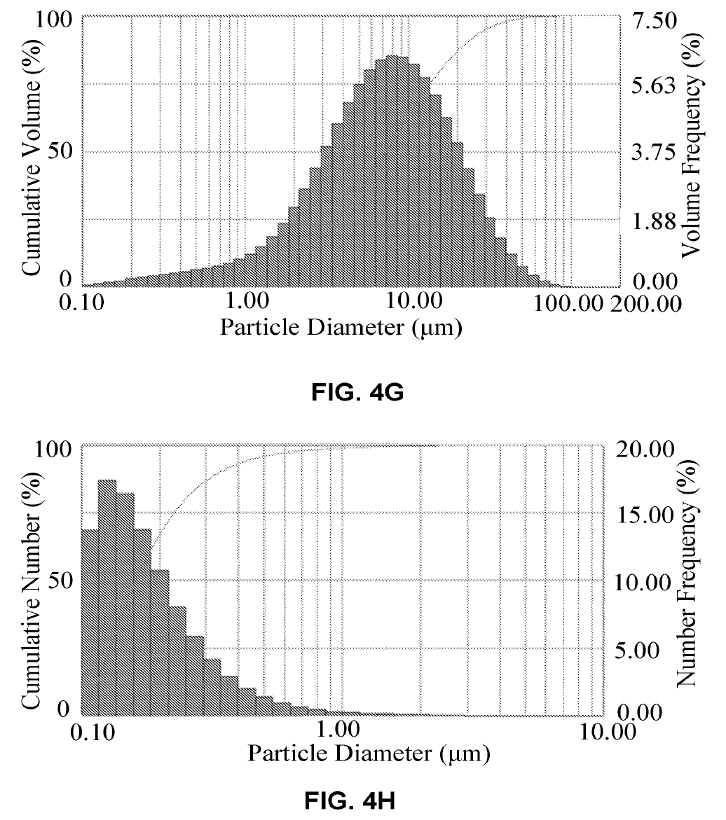

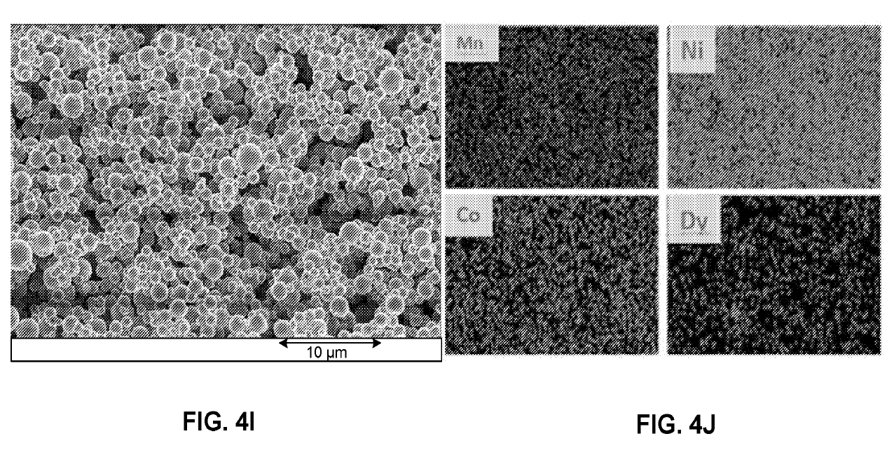

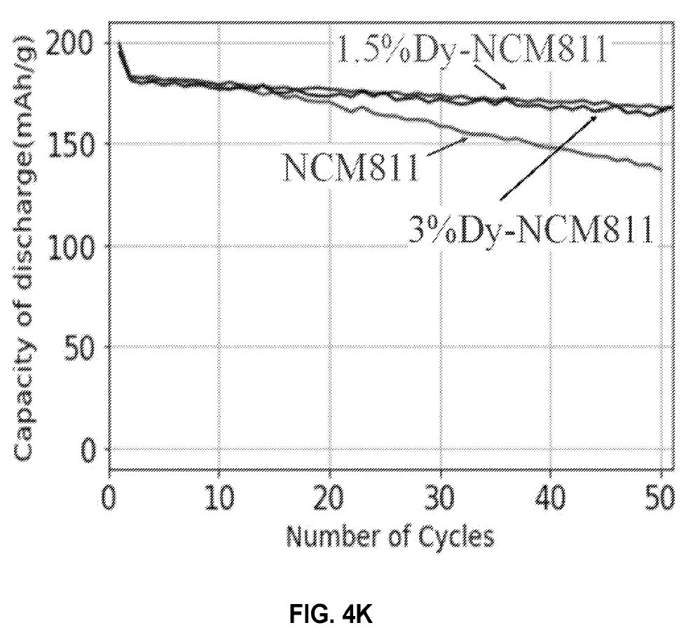

(Step 103) Preheating control. The aerosol obtained from the step 102 may be passed through a temperature controlled preheating region for particle morphology control before delivery to the high-temperature reactive zone downstream. The preheating can be achieved by either electrical heating in a fast mixing jet stirred reactor (e.g. IOS-JSR) (FIG. 3C) and/or low temperature flames (cool flames and warm flames) (as shown in FIGS. 4A-4D) . The size distribution of the droplet from the step 102 (e.g., sub-micron or dual-mode described above), coupled with the preheating temperature control in step 103 and synthesis temperature control in step 104, can be used to control the size distribution of the synthesized product particles, for example, monodisperse ultrafine particles (e.g., 5-100 nm size), or polydisperse particles (e.g., 5 nm-10 µm size).

FIG. 3C is graphical illustration of an inwardly off-center shearing jet-stirred reactor (IOS-JSR) 3000, consistent with various embodiments of the present disclosure. The components of the exemplary IOS-JSR 3000 presented herein are intended to be illustrative. Depending on the implementation, the IOS-JSR 3000 may include additional, fewer, or alternative components.

In some embodiments, the IOS-JSR 3000 may include an inlet 310 to receive the aerosol, a preheating zone 320, a decomposition zone 330 (i.e., the reactive zone), and an outlet 340 configured to deliver the synthesized particles for collection. The preheating zone 320 and decomposition zone 330 may each include a plurality of jets extending towards different directions. The plurality of jets may form one or more pairs. In one embodiment, the number of the jets in the preheating zone 320 is the same as the number of the jets in the decomposition zone 330; in another embodiment, the number of the jets in the preheating zone 320 is different from the number of the jets in the decomposition zone 330. For example, as shown in FIG. 3C, the preheating zone 320 includes four pairs of jets (321a and 321b, 322a and 322b, 323a and 323b, and 324a and 324b); and the decomposition zone 330 includes another four pairs of jets (331a and 331b, 332a and 332b, 333a and 333b, and 334a and 334b). In each zone, the jets can induce four vortices in different directions, producing a rapid turbulent motion to uniformly mix the hot gas and aerosol particles, which enables uniform heating to the aerosol particles. For example, in FIG. 3C, streamlines 350 are produced by the four pairs of off-center shearing jets (321a and 321b, 322a and 322b, 323a and 323b, and 324a and 324b) in the preheating zone 320. Therefore, the vortices can promote the mixing. This uniform mixing and heating is critical for achieving high quality particles with a narrow size distribution and well-controlled spherical shape.

In some embodiments, the IOS-JSR 3000 can be used for both precursor preheating and material synthesis. The temperature inside the preheating zone 320 and decomposition zone 330 gradually increases along the path of the aerosol jets in the reactor, i.e., in an inlet-to-outlet direction. The temperature of each zone may be controlled by varying the temperature of the hot gas jet (produced by flames or heating), the flow rate and the direction of the injection. The preheating zone 320 is configured to enable a controlled evaporation of the solvent in the aerosol. This step may be used to control the shape and formation of a concentration-gradient structure. Solid spherical particles can generally be obtained at low temperatures (100-150 ^{o}C) over a relatively long heating time (1-100 seconds). In some embodiments, after the particles are dried, they can be carried by the gas stream to the decomposition zone 330 where the temperature of the hot gas is slightly higher than the decomposition temperature of the precursor (500-10,000 ^{o}C). The decomposition temperature and residence time of the decomposition zone 330 provide the control of the porosity and morphology of the particles.

Referring back to FIG. 1 and FIG. 2A, in some embodiments, the aerosol flow can be preheated in a delivery line before feeding into a reactor, to facilitate control of the synthesized particle morphology. The preheating energy may be provided by electrical heating, cool flame or hot flame heating, or heat exchange with recirculated high-temperature exhaust gas described herein. In one example, the preheating temperatures can be between 50 ^{o}C and 500 ^{o}C to suppress or eliminate the formation of (1) hollow particles, or (2) sub-10 nm nanoparticles formed from the gas-phase-to-particle mode, by slowing the evaporation rate of solvent from the droplet (e.g., as compared to directly feeding into the reactor) and therefore providing time for the solute to diffuse within the droplets. A residence time in the preheating section may be 0.1-10 seconds.

(Step 104) reactor reaction. The aerosol from the step 103 is delivered to a reactive zone of the reactor, where the solvent liquid evaporates and reacts in the high-temperature reactor to form product particles. In some embodiments, the reactor is an IOS-JSR (as shown FIG. 3C). An IOS-JSR reactor or an alternative apparatus may provide the uniform and high-temperature reactive zone with a precise temperature control between 200-10,000 ^{o}C. Chemical conversion of the precursor into product particles occurs inside the reactor. The high-temperature may be achieved with a flame, a heated volume, a plasma, laser heating, electric heating, or their combination with or without additional gaseous precursors. Active flames (cool flames and hot flames), plasma radicals, or other energy sources can accelerate the production of homogeneous particles. The aerosol may pass directly through the reactive zone, or high-temperature gas(es) may be generated (e.g., by the flame or another energy source) and mixed with the aerosol stream to burn in the reactive zone (e.g., methane can be added to the aerosol stream and the mixture can be burnt with oxygen in a non-premixed co-flow burner configuration).

In some embodiments, the reaction temperature in the reactor may be 200-10000 ^{o}C, the pressure of the reactor may be 500 mbar-10 bar, and the residence time in the reactor may be 0.1-100 seconds. The high-temperature reactive zone may be formed by the burning of fuel and oxidizer either in a cool, warm, or hot flame. The fuel may contain carbon (e.g., methane, ethylene, propane and other alkanes and oxygenated fuels like alcohols and ethers). Alternatively, the fuel may comprise hydrogen (e.g., for high purity applications). The oxidizer stream may comprise air or a tailored oxygen/inert gas mixtures. The reactive zone may be surrounded by a co-flow of inert or oxidizing gases. The flowrates of the gases may be controlled using any ordinary method of flow regulation.

The flames, depending on their temperature, can be broadly categorized into three groups: hot flame with temperature higher than 1200 ^{o}C, warm flame with temperature between 800 ^{o}C and 1200 ^{o}C, and cold flame (also called cool flame) with temperature lower than 800 ^{o}C. The coexistence of a cool flame and a warm flame is called mild flame. A cool flame can reignite to form a warm flame or a hot flame. A warm flame can extinguish into a cool flame or ignite to a hot flame. Under certain conditions, a hot flame can extinguish directly into either a warm flame or a cool flame. FIGS. 4A-4D represent direct images of a diffusion cool flame, a premixed warm flame, a premixed cool flame and a diffusion warm flame respectively for low temperature flame (500-1200 K) materials synthesis. A diffusion flame is a flame in which the oxidizer combines with the fuel by diffusion. As a result, the flame speed is limited by the rate of diffusion. A premixed flame is a flame formed under certain conditions during the combustion of a premixed charge (also called pre-mixture) of fuel and oxidiser.

In some embodiments, these low temperature flames (warm flame and cool flame) can provide new heating and combustion environment for materials synthesis when high temperature flames may damage or significantly change the target crystal structure. For example, the battery materials, including cathode materials and anode materials, can be very sensitive to the temperature of the synthesis. In this case, only warm and cool flames can produce target crystal structures. For example, the cathode materials can be a combination of nickel, manganese and cobalt (NMC) nano-materials. When synthesizing the NMC materials, different temperatures can result in different gradients of the compositional materials. In some embodiments, the higher the temperature is, the larger the compositional gradient is; and the lower the temperature is, the lower the gradient is. When the synthesis temperature is too high, the gradient can be affected, and the efficiency of the cycle may be very low. Thus, in some embodiments, by controlling the temperature of the flames from the cool flame to warm and hot flame, the compositional gradient and the addition of elements can be precisely controlled.

In some embodiments, the flame (e.g. cool, warm, or hot flame) provides heat that evaporates the solvent and drives the reaction of the precursors into product particles. The flame also provides active radicals that accelerate the formation of crystalline product particles. The combination of flame structure, reactor residence time, fuel-oxidizer mixture, and precursor solvent controls the synthesis conditions, thereby controlling the crystallinity (e.g., crystal phase, crystallite size), hollowness, core-shell, or dense particles.

In some embodiments, the high-temperature reactive zone may be formed using a plasma discharge. In this case, the aerosol stream is introduced into the reaction chamber together with additional gases required for the formation of the product particles. The additional gases may comprise air, nitrogen, helium, argon, ammonia, or fluorine-containing gases. Electrical energy is imparted to the aerosol flow. For example, the reactor may comprise two electrodes with a voltage applied to them to generate a discharge, thereby forming the plasma. The discharge raises the gas temperature to evaporate the solvent. Active species in the plasma may assist in driving the chemical reactions, which form the product particles. In this case, the nature of the plasma discharge and flow residence time controls the morphology and the crystallinity of the product particles.

In some embodiments, the high-temperature reactive zone is formed by an electrically-heated reactor, for example, in a tubular furnace configuration. The reactor provides heat to the aerosol stream, evaporating the droplets and forming the product particles. The reactor temperature and residence time control crystallinity, microstructure, and morphology of the product particles.

Regardless of the reactor configuration, the material synthesis method comprises two primary routes for forming the product particles: droplet-to-particle (one particle forms from each droplet) and gas-to-particle (multiple particles form from each vaporized droplet) formation routes.

For the droplet-to-particle route, the solvent evaporates more slowly, and one particle forms from each droplet. The product particle size is between 10 nm and 100 µm (e.g., in the range of 10-50 nm, 50-100 nm, 100 nm-500 nm, 500 nm-1µm, 1-10 µm, 10-100 µm etc.), depending primarily on the atomizer device operation mode, precursor concentration, and preheating and reactor synthesis temperatures. For example, in the dual-mode, the synthesized particles may be polydisperse (e.g., 5 nm-10 µm). For another example, higher precursor concentrations may result in formation of larger particles. For another example, higher preheating temperatures may lead to formation of dense, smaller particles. For another example, lower synthesis temperatures may favor the formation of particles via this droplet-to-particle route. Further, it is possible to enhance the formation of hollow particles (shell formation) by using a low preheating temperature or no preheating, with intermediate downstream synthesis temperatures.

For the gas-to-particle route, the precursor is first vaporized into the gas-phase, and then particles form via nucleation and growth from the precursor vapor. In some embodiments, high synthesis temperatures (e.g., ~2500 ^{o}C) and/or highly energetic plasma discharges (e.g., ~10000 ^{o}C) may drive the gas-to-particle synthesis route to form ultrafine nanoparticles (5-100 nm) from the gas phase. This formation route may depend on the atomizer device operation mode, and preheating and reactor synthesis temperatures. For example, in the sub-micron atomizer operation mode, the particles may be predominantly ultrafine (5-100 nm). For another example, in the sub-micron atomizer operation mode, the high surface area of the droplets enhances the formation of ultrafine nanoparticles (5-100 nm) from the gas phase. For another example, preheating suppresses the gas-to-particle formation route by at least reducing the droplet vaporization rate. For another example, high synthesis temperatures favor the gas-to-particle formation route. Further, the reactor pressure may be atmospheric or the reactor pressure may be varied to adjust the particle morphology. Low reactor pressures may promote the formation of ultrafine nanoparticles (5-100 nm) via the gas-to-particle synthesis route due to higher vaporization rate at lower pressures.

(Step 105) particle collection. Through the variation of preheating and synthesis temperature following the gas-phase-to-particle mode, droplet-to-particle mode, and shell-to-hollow-particle mode, the morphology of nanoparticles such as monodispersed ultra-fine particles (5-100 nm), hollow particles, and polydisperse larger particles (5 nm-10 µm) can be controlled. The product particles may be collected from the process exhaust stream or directly deposited on a surface (thin films). The material synthesis system may comprise at least one of a membrane filter, electrostatic collector, a bag filter, a cold trap, or a substrate for collecting the synthesized particles from an exhaust stream of the reactor. For example, the particles may be collected from the exhaust stream using membrane filters, electrostatic collection, bag filters, cold trap, or any other suitable method. For another example, the nanoparticles can be deposited directly onto a substrate to form nanostructured thin films.

(Step 106) additional processing. Additional processing (e.g., annealing) may be implemented to improve the particle crystalline structure. The annealing temperature and duration can be configured to control the crystal phase and crystallite size. The synthesized material can be obtained at (step 107).

FIG. 4E to FIG. 4H illustrate controlling the synthesis of metal oxide nanoparticles and lithium-containing transition metal oxide particles (e.g., Li(Ni_{0.33}Mn_{0.33}Co_{0.33})O₂ for lithium-ion battery cathodes) with three different particle morphologies (monodispersed ultra-fine particles (5-100 nm), hollow particles, and polydisperse larger particles (5 nm-100 µm)).

In some embodiments, nitrates of lithium metal and nitrates of the transition metals nickel, manganese, and cobalt are dissolved in deionized water. The elemental ratios of the transition metals may be arbitrarily chosen. In one example, the atomic ratio of transition metals is 1:1:1, with the ratio of total transition metals to lithium 1:1, to form the electrochemically active cathode material Li(Ni_{0.33}Mn_{0.33}Co_{0.33})O₂. The total molar concentration of precursor salts in the mixture is 1 mol/L. In another example, the ratio of lithium to a single transition metal may be 1:2 to form the electrochemically active material LiMn₂O₄. In another example, a single metal precursor may be used, to form the metal oxide product M₂O₃, where M is a metal (e.g., yttrium, Y). For example, Y₂O₃ particles can be formed (where yttrium nitrate is dissolved in deionized water forming precursor liquid, which is supplied into the chamber of the atomization device).

In some embodiments, the prepared precursor solution is added to the atomizer described above. An atomizing gas comprising air is delivered to the atomizer at a pressure of approximately 2 bar(g). An aerosol of precursor solution droplets is generated in the atomizer, according to the process described above.

The precursor solution droplets may have a volume-based (mass-based) size distribution as shown in FIG. 4E-FIG. 4H. FIG. 4E and FIG. 4F are respectively graphical illustrations of volume-based and number-based droplet size distribution for a hydrocarbon-liquid-fuel-based precursor solution in the sub-micron mode, consistent with various embodiments of the present disclosure. In FIG. 4E and FIG. 4F, the droplets obtained from the corresponding liquid precursor are 95 RON (Research Octane Number) gasoline fuel droplets, with a viscosity of 0.46 mPa∙s, a surface tension of 17 mN/m, and a density of 734 kg/m³. As shown in FIG. 4E, in the sub-micron aerosol mode, the droplet mass is evenly distributed between the sub-micron range and the 1-100 µm range. There exists a cubic relationship between the diameter and volume of spherical droplets. For example, 1000 droplets with a diameter of 100 nm have the same total volume as a single droplet with a diameter of 1 µm. Therefore, the right peak in FIG. 4E may correspond to very few micron-size droplets in FIG. 4F, and as shown in FIG. 4F, the vast majority (e.g., more than 99% by number) of droplets are in the sub-micron range (e.g., 100-1000 nm size). This sub-micron distribution is more suitable for producing monodisperse particles in the synthesis process.

FIG. 4G and FIG. 4H are respectively graphical illustrations of volume-based and number-based droplet size distribution for a water-based precursor solution for the dual-mode, consistent with various embodiments of the present disclosure. In FIG. 4G and FIG. 4H, the droplets obtained from the corresponding liquid precursor are deionized water droplets, with a viscosity of 0.89 mPa∙s, a surface tension of 72.8 mN/m, and a density of 998 kg/m³. As shown in FIG. 4G, in the dual mode, the mass is weighted toward the 1-100 µm droplet size range. As shown in FIG. 4H, by numbers, the atomizer produces droplets of a broader size distribution than the sub-micron mode, and the aerosol comprises both sub-micron and larger droplets 1-100 µm, which correspond to the “dual modes.” This dual-mode distribution is more suitable for producing polydisperse particles in the synthesis process.

FIG. 4I is a graphical illustration of SEM data of an exemplary high nickel cathode material, and FIG. 4J is a graphical illustration of energy-dispersive X-ray (EDX) mapping data of the exemplary high nickel cathode material, consistent with various embodiments of the present disclosure. In some embodiments, the atomic ratio of nickel, cobalt, and manganese high nickel cathode material is 0.8:0.1:0.1 (NCM811), and the material is doped with 1.5% dysprosium (Dy) (Dy-doped NCM811). The SEM data in FIG. 4I shows the surface topography of the material, and the EDX data mapping data shows the compositional distribution in the material. As shown in FIG. 4I and FIG. 4J, each element may be uniformly distributed across the product, of which, a small amount of ions (e.g., Dy) can be uniformly doped into the cathode materials.

FIG. 4K is a graphical illustration of cycling performance of NCM811 nanomaterial and 1.5% Dy doped NCM811 nanomaterial and 3% Dy doped NCM811 nanomaterial, consistent with various embodiments of the present disclosure. A charge cycle is the process of charging a rechargeable battery and discharging it as required into a load. The cycling performance refers to the number of cycles for a rechargeable battery, which indicates how many times it can undergo the process of complete charging and discharging until failure or it starting to lose capacity. As shown in FIG. 4K, compared with the undoped NCM811 nanomaterial, NCM811 nanomaterials doped with a small amount of Dy present a more stable discharge capacity with the increased number of cycles. As such, it is likely that a small amount of Dy doping can increase the cycling stability of the lithium ion battery, which is consistent with the ion doping, such as lanthanide ion doping in the present disclosure.

In some embodiments, the aerosol can be delivered through a preheating section with an exit temperature of, for example, 50-500 ^{o}C. For example, the preheating may be delivered by electrical resistance heaters. The aerosol may be delivered to the reactive zone. The reactive zone may comprise a diffusion flame burner operated with gases containing, for example, methane, oxygen, and nitrogen. An air co-flow surrounds the burner. The entire reactive zone may be enclosed and operated at atmospheric pressure. The aerosol flow is injected into the burner. The adiabatic temperature of the mixed gases is between 700-2500 ^{o}C. The residence time of the aerosol in the reactor is 0.1-10 seconds (e.g., 0.5-5 seconds). The product particles may be collected from an exhaust stream using a filter assisted with a vacuum pump, or using an electrostatic precipitator. The particles may also be directly deposited onto a substrate for the formation of thin films.

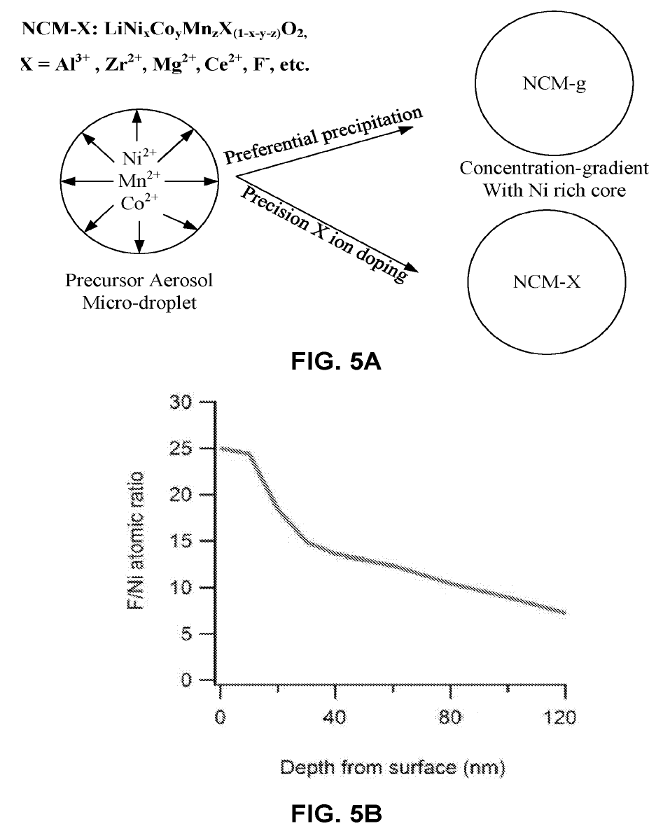

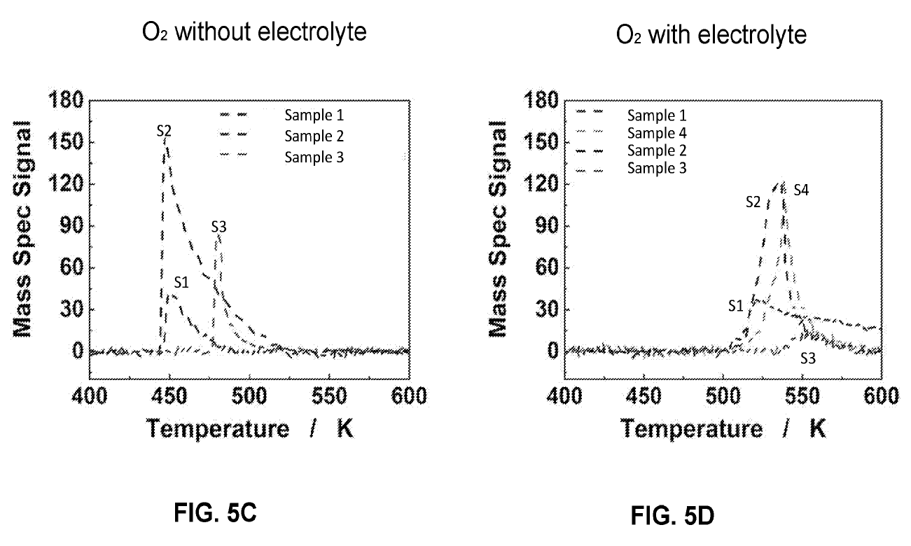

FIG. 5A is a graphical illustration of formation of NCM cathode nanomaterials with concentration gradient (NCM-g) and precision doping (NCM-X), consistent with various embodiments of the present disclosure. As shown in FIG. 5A, to synthesize high nickel NCM cathode nanomaterials with the micro aerosol pyrolysis method, precursor aerosol micro-droplets of nickel, manganese and cobalt ions are prepared. In the micro-droplets, the nickel, manganese and cobalt ions are evenly distributed. In some embodiments, with the preferential precipitation, NCM cathode nanomaterials with Ni centration gradient (NCM-g) can be formed. The NCM-g materials have a nickel rich core, and the concentration of nickel gradually decreases from the center to the surface. In some embodiments, by controlling the solubility of different solutes and vaporization rate of the micro aerosol, the micro-droplets of the NCM can be doped with X and form X-doped NCM cathode nanomaterials (NCM-X). The ratio of X element doped into the NCM cathode materials can be precisely controlled. In some embodiments, the NCM-X cathode nanomaterials may have a chemical formula as: LiNiₓCo_{y}Mn_{z}X_{(1-x-y-z)}O_{2,} and the X element may be selected at least one from the group of aluminum, zirconium, magnesium, cerium, fluorine, silver, etc.

FIG. 5B is a X-ray photoelectron spectroscopy (XPS) data of a fluorine doped high nickel NCM material, consistent with various embodiments of the present disclosure. The fluorine doped NCM cathode nanomaterial is synthesized by the micro aerosol pyrolysis method. Concentration gradient of fluorine between the core and surface were measured by depth profile using the XPS. FIG. 5B shows the distribution of atomic ratio of fluorine to nickel as a function of depth from the NCM nanoparticle surface. As shown in the data, the concentration of fluorine anion decreases from the surface to the center. Thus, fluoride anion was doped into the NCM materials with a concentration gradient of fluoride anion from the surface to the core.

FIG. 5C and 5D are respectively graphical illustrations of oxygen release data as a function of temperature for NCM811 cathode materials with and without electrolyte solvents, consistent with various embodiments of the present disclosure. As shown in FIG. 5C, the oxygen release data for samples 1, 2, and 3 (S1, S2, and S3) without electrolyte solvents all show peak positions between 450 K and 500 K, indicating in these samples, oxygen mostly is released below the temperature of 500 K. FIG. 5D shows the oxygen release data as a function of temperature for samples 1, 2, 3 and 4 (S1, S2, S3, and S4) with electrolyte. Compared with the data in FIG. 5C, the oxygen release data in FIG. 5D shows the peak positions above 500 K. Particularly, for S3, which is an F-doped NCM811, the peak position temperature is around 550 K, and the peak value of the oxygen release drops from about 80 (shown in FIG. 5C) to about 15 (shown in FIG. 5D). Therefore, doping F-ion in NCM811 nanomaterials may increase the oxygen release temperature, thus reduces the propensity of spontaneous auto-ignition of lithium ion batteries.

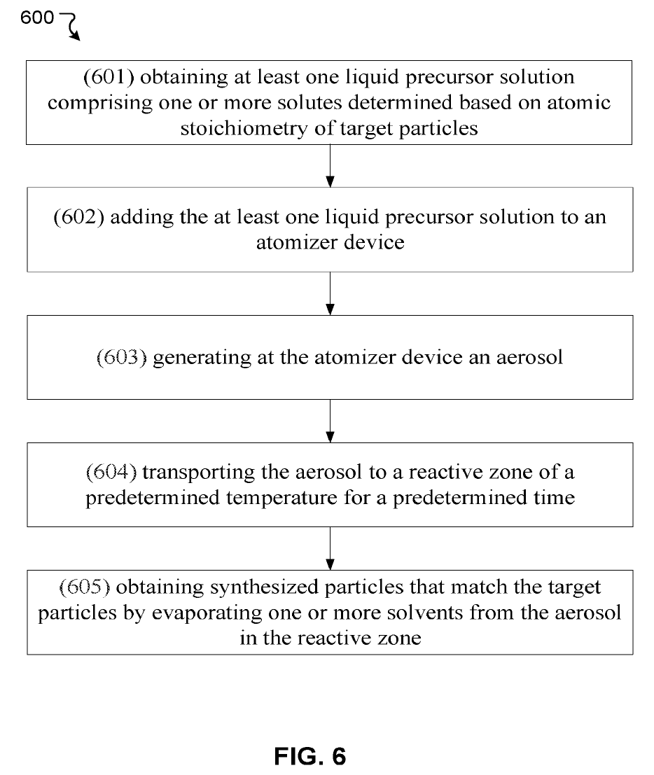

FIG. 6 is a flowchart illustrating an exemplary material synthesis method 600, consistent with various embodiments of the present disclosure. The operations of the exemplary material synthesis method 600 and its various steps presented herein are intended to be illustrative. Depending on the implementation, the exemplary material synthesis method 600 may include additional, fewer, or alternative steps performed in various orders or in parallel.

Step 601 comprises obtaining at least one liquid precursor solution. The at least one liquid precursor solution may include one or more solutes determined based on atomic stoichiometry of target particles. In some embodiments, the at least one liquid precursor solution may comprise a metal salt dissolved or diluted in a solvent. In some embodiments, the at least one liquid precursor solution may comprise at least two different metal salts dissolved or diluted in a solvent. The metal salt may comprise at least one of alkaline, transition, lanthanide metals or any oxygen coordination metal. The at least two different metal salts may have different solubilities. The solvent may comprise at least one of water, metal alkoxide, or one or more hydrocarbon liquids. The median size of the synthesized particles by the method 600 may increase with the molar concentration of the liquid precursor solution. The at least one liquid precursor solution may have a dynamic viscosity of less than 0.2 Pa∙s and a molar concentration of 0.001-2 mol/L (e.g., 0.1-2 mol/L).

Step 602 comprises adding the at least one liquid precursor solution to an atomizer device. Step 603 comprises generating by the atomizer device an aerosol. The aerosol may comprise liquid droplets. In some embodiments, for a sub-micron mode of the atomizer device, at least 99% of the liquid droplets by number have a diameter of less than 1 µm and an arithmetic mean diameter between 0.1 and 1 µm, and the particles produced by the method 600 are monodisperse with an average diameter between 5-100 nm. For a dual mode of the atomizer device, the liquid droplets are sub-micron sized in diameter or 1-100 µm in diameter, and the particles produced by the method 600 are polydisperse with diameters between 5 nm-10 µm. For example, the atomizer device may comprise a microspray atomizer. Generating the aerosol may comprise introducing an atomizing gas flow into the microspray atomizer and generating the aerosol in the microspray atomizer. The atomizing gas may comprise at least one of an oxidizer gas, an inert gas, or a fuel gas. The atomizing gas flow may have a pressure of 1-100 bar (e.g., 1-10 bar).

Step 604 comprises transporting the aerosol to a reactive of a predetermined temperature for a predetermined time. The reactive zone may comprise at least one of a flame, plasma, furnace, laser heating, or electric heating for supplying energy. The flame may be a cold flame, warm flame, hot flame, or a combination thereof. The reactive zone may be at a temperature of 200-10000 ^{o}C and a pressure of 500 mbar-10 bar. In some embodiments, transporting the aerosol to the reactive zone may comprise transporting the aerosol to the reactive zone without preheating, and the synthesized particles by the method 600 are hollow-structured.

Optional step 604 comprises transporting the aerosol to a preheating zone for evaporating at least a portion of the one or more solvents from the aerosol. For example, preheating the aerosol may be performed at a temperature between 50 ^{o}C and 500 ^{o}C for evaporating at least the portion of the one or more solvents from the aerosol for 0.1-10 seconds. Energy for the preheating can be provided by at least one of electrical heating, combustion heating, or heat exchange with a recirculated exhaust gas.

Step 605 comprises obtaining synthesized particles that match the target particles by evaporating one or more solvents from the aerosol in the reactive zone. In some embodiments, obtaining the synthesized particles comprises evaporating the one or more solvents from the aerosol at a uniform temperature between 200-10000 ^{o}C and a pressure of 500 mbar - 10 bar for 0.1-100 seconds. In some embodiments, obtaining the synthesized particles comprises evaporating the one or more solvents from the aerosol for 0.1-10 seconds (e.g., 0.5-5 seconds). In some embodiments, the one or more solvents are evaporated by at least one of a flame (cool flame, warm flame, or hot flame), plasma, furnace, laser heating, or electric heating. In some embodiments, obtaining the synthesized particles comprises collecting the synthesized particles from an exhaust stream of the reactive zone by membrane filtering, electrostatic collection, bag filtering, or cold trap. The synthesized particles may comprise a metal oxide, fluoride, sulphide, oxysulphide, silicate, nitrate or nitride. The synthesized particles may comprise homogeneous and non-aggregated particles. For example, the synthesized particles may comprise particles selected from a group consisting of: monodisperse Li(Ni_{0.33}Mn_{0.33}Co_{0.33})O₂ particles with an average diameter between 5-100 nm, hollow-structured Li(Ni_{0.33}Mn_{0.33}Co_{0.33})O₂ particles, LiMn₂O₄ which has a mean diameter between 5-10 nm, and polydisperse Li(Ni_{0.33}Mn_{0.33}Co_{0.33})O₂ particles with diameters between 5 nm-10 µm. Further details of the method 600 can be found above with reference to FIG. 1 to FIG. 11.

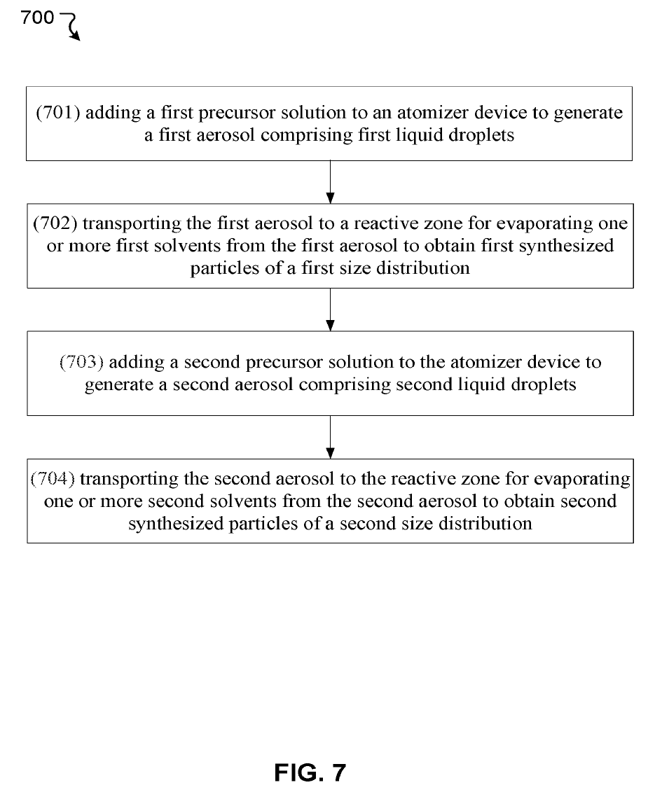

FIG. 7 is a flowchart illustrating an exemplary material synthesis method 700, consistent with various embodiments of the present disclosure. The operations of the exemplary material synthesis method 700 and its various steps presented herein are intended to be illustrative. Depending on the implementation, the exemplary material synthesis method 700 may include additional, fewer, or alternative steps performed in various orders or in parallel.

Step 701 comprises adding a first precursor solution to an atomizer device to generate a first aerosol comprising first liquid droplets. Step 702 comprises transporting the first aerosol to a reactive zone for evaporating one or more first solvents from the first aerosol to obtain first synthesized particles of a first size distribution. Step 703 comprises adding a second precursor solution to the atomizer device to generate a second aerosol comprising second liquid droplets. Step 704 comprises transporting the second aerosol to the reactive zone for evaporating one or more second solvents from the second aerosol to obtain second synthesized particles of a second size distribution. Before the step 703 is performed, the atomizer device may be emptied such that no first precursor solution is left. In some embodiments, the first precursor solution may comprise gasoline, and the second precursor solution may comprise water. Alternatively, the first precursor solution may comprise water, and the second precursor solution may comprise gasoline. In addition, various other liquids can be used instead of gasoline and water. The liquids may have various different viscosity, density, and surface tension measurements. In some embodiments, droplets of higher viscosity, surface tension, and density (e.g., no less than deionized water in such measurements) may be used for the dual mode of the atomizer device, while droplets of lower viscosity, surface tension, and density (e.g., no more than 95 RON gasoline in such measurements) may be used for the submicron mode of the atomizer device.

In some embodiments, generating the first or second aerosol comprises disintegrating liquid films of the first or second precursor solution respectively with gas jets; and the first and second precursor solutions are associated with different surface tensions.

In some embodiments, the first and second size distributions are selected from monodisperse and polydisperse distributions (e.g., the first size distribution may be monodisperse and the second distribution may be polydisperse and vice versa). The monodisperse distribution is associated with an average diameter between 5-100 nm, and is obtained from corresponding liquid droplets that at least 99% by number of which have a diameter of less than 1 µm or an arithmetic mean diameter between 0.1 and 1 µm. The polydisperse distribution is associated with diameters between 5 nm-10 µm, and is obtained from corresponding liquid droplets that are sub-micron in diameter or 1-100 µm in diameter. The monodisperse distribution may correspond to the above-described sub-micron mode, and the polydisperse distribution may correspond to the above-described dual mode. Various other synthesis conditions (e.g., preheating and reactor temperature, pressure, and residence time) can be referred to from the above descriptions.

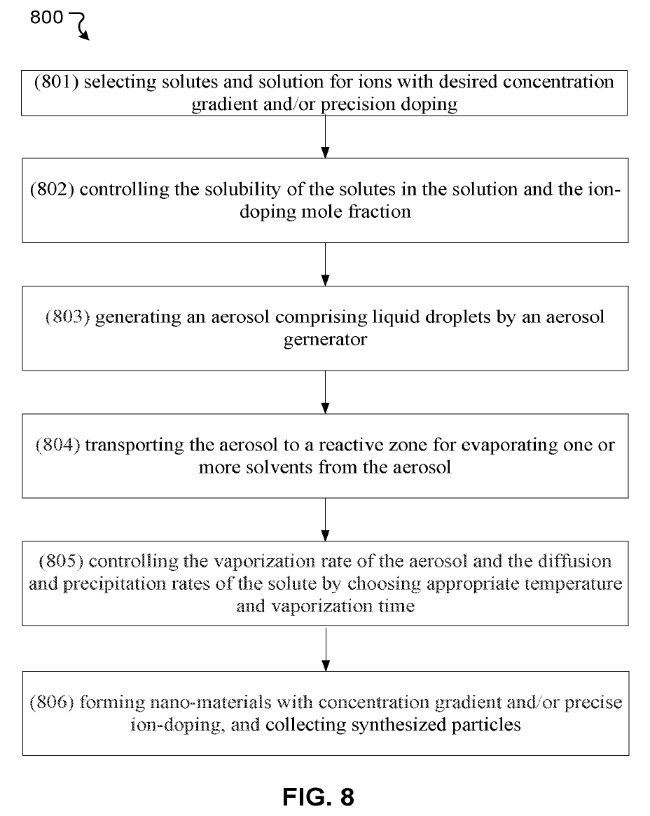

FIG. 8 is a flowchart illustrating an exemplary material synthesis method 800, consistent with various embodiments of the present disclosure. The operations of the exemplary material synthesis method 800 and its various steps presented herein are intended to be illustrative. Depending on the implementation, the exemplary material synthesis method 800 may include additional, fewer, or alternative steps performed in various orders or in parallel.

Step 801 comprises selecting solutes and solution for ions with target concentration gradient and/or precision doping. In some embodiments, the solutes can be determined based on composition stoichiometry of target particles. In some embodiments, the selection of solutes and solution can be determined by a computer. Based on the composition stoichiometry, a computer may automatically select the solutes and solution for the material synthesis. Step 802 comprises controlling the solubility of the different solutes in the solution for forming particles with a compositional gradient, and/or controlling ion doping mole fraction. Step 803 comprises generating a micro aerosol by using an aerosol generator, such as an atomizer device. Step 804 comprises transporting the aerosol to a reactive zone for evaporating one or more solvent form the aerosol. Step 805 comprises controlling the vaporization rate of the aerosol and the diffusion and precipitation rates of the solute by choosing appropriate temperature and vaporization time. Step 806 comprises forming nano-materials with concentration gradient and/or precise ion-doping, and collecting synthesized particles. The nano-materials can be formed by pyrolysis and oxidation at controlled high temperatures by, for example, heating, combustion, plasma, etc.

As such, various materials can be efficiently synthesized by the disclosed method. For example, controlling the nanostructure and size of cathode and anode materials (e.g., layered transition metal oxide particles such as Li(Ni_{0.33}Mn_{0.33}Co_{0.33})O₂)allows reduction of Li-ion diffusion time, increased surface areas and packing density, and optimization of electronic conduction to enhance battery specific capacity and charge/discharge rates, while also reducing adverse chemical reactions and/or structural changes. The particle size control methods disclosed herein can, in a single processing step, benefit battery calendar lifetime, cycle numbers, and battery safety. The single processing step can obviate the separation/sieving required in existing technologies. A further example is the tailoring of optical properties to improve absorption efficiency of photoactive materials such as transition-metal doped TiO₂. Still another example is the increased catalytic activity of nanomaterials (e.g., rare-earth perovskites or noble metals on oxide supports) due to the extremely high specific surface area. Yet another example is to control particle size and morphology of thermal-chemical energy storage materials to achieve efficient and fast energy storage. A further example is the synthesis of thin films using a combination of different nanomaterials to control the sensitivity and functionality of thin films.

The present disclosure recites many ranges in, for example, temperature, pressure, dimension, time, solubility, etc. In some instances, a broad range is given with exemplary narrower ranges. These exemplary narrower ranges are not repeated in other instances where the broad range is described, but are also applicable in those instances.

Advantages of the disclosed material synthesis method include: versatility (nanoparticles of different materials can be manufactured, using solvents with very different properties), simplicity, controllable particle sizes including a monodisperse ultrafine mode and a polydisperse mode, very short process time, scalability of production rate, and economic efficiency (low costs required for construction and operation).

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

What is claimed is:

1. A material synthesis method, comprising:
obtaining at least one liquid precursor solution comprising one or more solutes determined based on atomic stoichiometry of target particles;
adding the at least one liquid precursor solution to an atomizer device;
generating at the atomizer device an aerosol;
transporting the aerosol to a reactive zone of a predetermined temperature for a predetermined time; and
obtaining synthesized particles that match the target particles by evaporating one or more solvents from the aerosol in the reactive zone.

2. The method according to claim 1, wherein:
the at least one liquid precursor solution comprises a metal salt dissolved or diluted in a solvent;
the one or more solutes comprise the metal salt;
the metal salt comprises at least one of: alkaline metal, transition metal, lanthanide metal or oxygen coordination metal;
the solvent comprises at least one of: water, metal alkoxide, one or more hydrocarbon liquids, or one or more alcohol liquids; and
a median size of the synthesized particles increases with a molar concentration of the liquid precursor solution.

3. The method according to claim 1, wherein:
the synthesized particles comprise one or more elements with uniform concentration gradient from surface to center.

4. The method according to claim 3, wherein:
the one or more solutes are determined based on a solubility of the one or more solutes; and
the concentration gradient depends at least on one or more of the solubility of the one or more solutes, an ion diffusion rate of ions in the at least one liquid precursor solution, an ion precipitation rate of the ions in the at least one liquid precursor solution, and a solvent evaporation rate of the at least one liquid precursor solution.

5. The method according to claim 1, wherein the synthesized particles are doped with ions of a predetermined molar concentration, wherein the predetermined molar concentration depends at least on a solubility of each of the one or more solutes.

6. The method according to claim 1, wherein the transporting the aerosol to a reactive zone of a predetermined temperature for a predetermined time comprises:
setting an environment of the reactive zone by setting a combination of a temperature, a flow rate, and a direction of heating gas injected into the reactive zone.

7. The method according to claim 1, wherein, before transporting the aerosol to the reactive zone, the method further comprises:
transporting the aerosol to a preheating zone; and
evaporating at least a portion of the one or more solvents from the aerosol for 0.0-1 seconds by preheating the aerosol at a temperature between 50 ^{o}C and 500 ^{o}C.

8. The method according to claim 7, wherein:
preheating the aerosol comprises preheating the aerosol with at least one of: a cool flame, a warm flame, an electrical heating, a combustion heating, or a heat exchange with a recirculated exhaust gas.

9. The method according to claim 1, wherein:
the reactive zone comprises at least one of: a flame, plasma, furnace, laser heating, or electric heating;
the reactive zone is at a temperature of 500-10000 ^{o}C and a pressure of 500 mbar - 10 bar; and
the evaporating one or more solvents from the aerosol in the reactive zone comprises evaporating one or more solvents from the aerosol for 0.0-1 seconds.

10. The method according to claim 9, wherein the flame includes one or more of: a hot flame with a temperature higher than 1200 ^{o}C, a warm flame with a temperature between 800 ^{o}C and 1200 ^{o}C, and a cold flame with a temperature lower than 800 ^{o}C.

11. The method according to claim 1, wherein:
the synthesized particles comprise a metal oxide, a metal fluoride, a metal chloride , a metal sulphide, a metal oxysulphide, a metal silicate, a metal nitrate, a metal acetate, or a metal nitride; and
the synthesized particles comprise non-aggregated particles.

12. The method according to claim 1, wherein the synthesized particles comprise nickel-cobalt-manganese nano-particles doped with: aluminum ions, antimony ions, tantalum ions, titanium ions, zirconium ions, magnesium ions, cerium ions, fluorine ions, silver ions, oxygen coordination ions, or lanthanide ions.

13. A material synthesis system, comprising:
an atomizer device configured to receive at least one liquid precursor solution and generate an aerosol from the at least one liquid precursor, wherein the at least one liquid precursor solution comprises one or more solutes determined based on atomic stoichiometry of target particles; and
a reactor comprising:
a preheating zone configured to preheat the aerosol; and
a reactive zone configured to evaporate one or more solvents from the aerosol and obtain synthesized particles that match the target particles.

14. The system according to claim 13, wherein the reactor is an inwardly off-center shearing jet-stirred reactor.

15. The system according to claim 13, wherein the preheating zone and the reactive zone each include one or more pairs of heating gas jets configured to inject a heating gas in one or more directions and mix the injected heating gas and the aerosol for uniform mixing and heating of the aerosol.

16. The system according to claim 15, wherein a temperature in the reactor increases along the reactor in a direction from an inlet of the aerosol to an outlet of the aerosol, and an environment of the reactive zone is set by a combination of a temperature, a flow rate, and a direction of the heating gas injected into the reactive zone.

17. The system according to claim 13, wherein:
the reactor comprises at least one of a flame, plasma, furnace, laser heating, or electric heating;
the preheating zone is at a temperature between 50 ^{o}C and 500 ^{o}C and configured to evaporate at least a portion of the one or more solvents from the aerosol for 0.0-1 seconds; and
the reactive zone is configured to evaporate the one or more solvents from the aerosol for 0.0-1 seconds.

18. The system according to claim 17, wherein the flame includes one or more of: a hot flame with a temperature higher than 1200 ^{o}C, a warm flame with a temperature between about 800 ^{o}C and about 1200 ^{o}C, and a cold flame with a temperature lower than 800 ^{o}C.

19. The system according to claim 13, wherein:
the one or more solutes are determined based on a solubility of the one or more solutes; and
the concentration gradient depends at least on one or more of the solubility of the one or more solutes, an ion diffusion rate of ions in the at least one liquid precursor solution, an ion precipitation rate of the ions in the at least one liquid precursor solution, and a solvent evaporation rate of the at least one liquid precursor solution.

20. The system according to claim 13, wherein the synthesized particles are doped with ions of a predetermined molar concentration, wherein the predetermined molar concentration depends at least on a solubility of each of the one or more solutes.
